(19) United States
(12) Patent Application Publication
(10) Pub. No.: US 2024/0190621 A1
(43) Pub. Date: Jun. 13, 2024

(54) PLUG-AND-PULL BALL STRUCTURE, A MASCARA TUBE AND A LIP GLOSS TUBE

(71) Applicant: Zhejiang UKPACK Packaging Co., Ltd, Yuyao City (CN)

(72) Inventor: Wei JIANG, Yuyao City (CN)

(73) Assignee: Zhejiang UKPACK Packaging Co., Ltd, Yuyao City (CN)

(21) Appl. No.: 18/211,870

(22) Filed: Jun. 20, 2023

(30) Foreign Application Priority Data
Dec. 8, 2022 (CN) 202223295163.6

(51) Int. Cl. B65D 41/16

(52) U.S. Cl. CPC B65D 41/16

(57) ABSTRACT

A plug-and-pull ball structure, mascara tube and lip gloss tube, which include outer cap, inner cap, ball and bottle body; outer cap is installed on the outside of inner cap, combination structure of inner cap and outer cap is fit to the body through a plug-and-pull mechanism; the ball is installed on inner cap. To plug in combination structure, outer cap will drive ball toward body, so ball interferes with body; to pull out combination structure, body will drive ball toward outer cap, so ball interferes with outer cap. Relied upon is the immovable structure including ball and body groove that is disposed between inner and outer cap combination. Instead of guaranteeing the airtightness of traditional cap-bottle combination through threaded connection, its bottle-cap combination does not have to rotate the thread, and the combination can be directly plugged and pulled without compromising the airtight effect.

### TECHNICAL FIELD

The present invention relates to the structural field of a plug-and-ball device for cosmetics, in particular to a plug-and-pull ball structure, a mascara tube and a lip gloss tube.

### BACKGROUND ART

For traditional products such as mascara and lip gloss, the cap is adjoined to the bottle by threaded connection, a kind of connection considered unfriendly to user (no detail is described here), making it necessary to provide a structure that can be directly plugged and pulled without airtightness compromised when closed.

### SUMMARY OF THE INVENTION

With respect to the defects found in the prior art, the object of this present invention is to provide a plug-and-pull structure, a mascara tube and a lip gloss tube.

A plug-and-pull structure provided under this present invention comprises an outer cap, an inner cap, a ball and a bottle body;

The said outer cap is installed on the outside of the said inner cap, and the combination structure of the said inner cap and the said outer cap is fit to the said bottle body through a plug-and-pull mechanism;

The said ball is installed on the said inner cap. To plug in the said combination structure, the said outer cap will drive the said ball toward the said bottle body, so the said ball interferes with the said bottle body; to pull out the said combination structure, the said bottle body will drive the said ball toward the said outer cap, so the said ball interferes with the said outer cap.

Preferably, the inner wall of the said outer cap is disposed a movable groove and a first immovable groove, the said outer cap has one end opened and the other end closed, the said first immovable groove is disposed on the side away from the opening of the said movable groove, the said inner cap is installed in the said outer cap from the opening of the said outer cap;

A sliding groove is disposed on the side wall of the inner cap, and the said ball is installed in the said sliding groove;

A second immovable groove is disposed on the outside of the neck part of the said bottle body.

Preferably, when the said combination structure is being plugged in the said bottle body, the said movable groove presses the ball on the outside of the neck part of the bottle body until the ball moves in the said second immovable groove, and the closed end of the said outer cap drives the inner cap to move;

When the said combination structure is installed on the said bottle body, one end of the said ball is snapped into the said second immovable groove and interferes with the movement of the bottle body, and the other end of the said ball moves from the said immovable groove into the said first immovable groove.

When the said combination structure is being pulled out of the said bottle body, the said outer cap moves relative to the said inner cap, one end of the said ball rolls from the said first immovable groove to the said movable groove and disengages from the second immovable groove, the said ball will no longer interfere with the bottle body, and the said outer cap causes the said inner cap to move as the said ball interferes with the said movable groove;

When the combination structure is being disengaged from the said bottle body, the said outer cap causes the said inner cap to move as the said ball interferes with the said movable groove.

Preferably, the distance between the bottom part of the said movable groove and the inside face of the said outer cap is greater than that between the bottom part of the said first immovable groove and the inside face of the said outer cap.

Preferably, the said sliding groove is configured as a circular cone form, the diameter of the end face of the sliding groove oriented toward the inside of the side wall of the said inner cap is less than that oriented toward the outside of the side wall of the said inner cap, and the diameter of the said ball is larger than the diameter of the end face of the said sliding groove oriented toward the inside of the side wall of the said inner cap.

Preferably, the said movable groove, the said first immovable groove and the said second immovable groove are configured as arc surfaces.

Preferably, a spring is disposed between the said inner cap and the closed end of the said outer cap.

Preferably, a sealing element is disposed on the side where the said inner cap is away from the closed end of the said outer cap, an inner plug is disposed on the inside of the neck part of the said bottle body. When the said combination structure is assembled to the said bottle body, the said sealing element is interference fit with the inner plug to form the seal.

Preferably, the said outer cap comprises an upper outer cap and a lower outer cap, the said lower outer cap is installed on the outside of the said inner cap, and the said upper outer cap is installed on the top of the said lower outer cap and the said inner cap.

Preferably, a protrusion from the side wall inside the lower outer cap is set against the said ball, and the outer diameter of the side wall of the said inner cap in the upper and lower parts of the protrusion is less than the outer diameter of the side wall of the said inner cap.

Preferably, a first slot and a second slot are disposed on the side wall outside the inner cap above the said protrusion disposed on the side wall inside the said lower outer cap, and a rib is disposed on the side wall outside the lower outer cap.

Preferably, when the said combination structure is being plugged in the said bottle body, the said movable groove presses the ball on the outside of the neck part of the bottle body until the ball moves in the said second immovable groove, the closed end of the said outer cap drives the inner cap to move, and the said rib moves into the said second slot;

When the said combination structure is installed on the said bottle body, one end of the said ball is snapped into the said second immovable groove and interferes with the movement of the bottle body, and the other end of the said ball moves from the said immovable groove into the said first immovable groove;

When the said combination structure is being pulled out of the said bottle body, the said outer cap moves relative to the said inner cap, one end of the said ball rolls from the said first immovable groove to the said movable groove and disengages from the second immovable groove, the said ball will no longer interfere with the bottle body, the said outer cap causes the said inner cap to move as the said ball interferes with the said movable groove, and the said rib is disengaged from the said second slot;

When the combination structure is being disengaged from the said bottle body, the said outer cap causes the said inner cap to move as the said ball interferes with the said movable groove. Compared with the prior art, this present invention delivers the following beneficial effects:
1. The present application relies on the immovable structure comprising the ball and the bottle body groove that is disposed between the inner and outer cap combination. Instead of guaranteeing the airtightness of traditional cap-bottle combination through threaded connection, its bottle-cap combination does not have to rotate the thread, and the combination can be directly plugged and pulled without compromising the airtight effect. This plug-and-pull ball structure tends to be more user-friendly compared to the threaded connection mechanism;
2. This plug-and-pull ball structure is applied to mascara and lip gloss products. Once plugged tightly, the brush tip can directly grab the material at the bottom part, which addresses the problem that the brush tip of traditional product in threaded connection cannot directly grab the material at the bottom part, and the step of retightening thread is required to do this. The above structure permits reduced residues and full use of mascara and lip gloss products.

### BRIEF DESCRIPTION OF THE DRAWINGS

Other features, objects and advantages of the present invention will become more apparent by reading the detailed description of non-limiting embodiments with reference to the following drawings:

FIG. 1 is a structural schematic diagram when the combination structure of the present invention is installed on the bottle body;

FIG. 2 is a structural schematic diagram when the combination structure of the present invention is being plugged into, or pulled out of the bottle body;

FIG. 3 is a structural schematic diagram when the combination structure of the present invention is being disengaged from the bottle body;

FIG. 4 is a relative location diagram of the ball, the movable groove, first fixed groove and the second fixed groove when the present invention is installed;

FIG. 5 is a structural schematic diagram of the outer cap as a part of the present invention;

FIG. 6 is a structural schematic diagram of the inner cap as a part of the present invention;

FIG. 7 is a structural schematic diagram of the bottle body as a part of the present invention;

FIG. 8 is a structural schematic diagram when the modified combination structure of the present invention is installed on the bottle body;

FIG. 9 is a structural schematic diagram when the modified combination structure of the present invention is being plugged into, or pulled out of the bottle body;

FIG. 10 is a structural schematic diagram when the modified combination structure of the present invention is being disengaged from the bottle body;

FIG. 11 is a relative location diagram of the ball, the movable groove and the protrusion when the present invention is installed;

FIG. 12 is a relative location diagram of the ball, the movable grove, the first slot and the second slot when the present invention is installed.

Designations: 1. Outer cap, 2. Inner cap, 3. Ball, 4. Inner plug, 5. Bottle body, 6. Spring, 7. Movable groove, 8. The first immovable groove, 9. The second immovable groove, 10. Sliding groove, 11. Sealing element, 12. Upper outer cap, 13. Lower outer cap, 14. Protrusion, 15. The first slot, 16. The second slot.

### DESCRIPTION OF THE EMBODIMENTS

The present invention is described below in conjunction with specific embodiments. The embodiments illustrated below will help those skilled in the art to further understand the present invention, but do not limit the present invention in any form whatsoever. As noted, those skilled in the art can make some changes and improvements without departing from the concept of the present invention. These are protected under the present invention.

### Embodiment 1

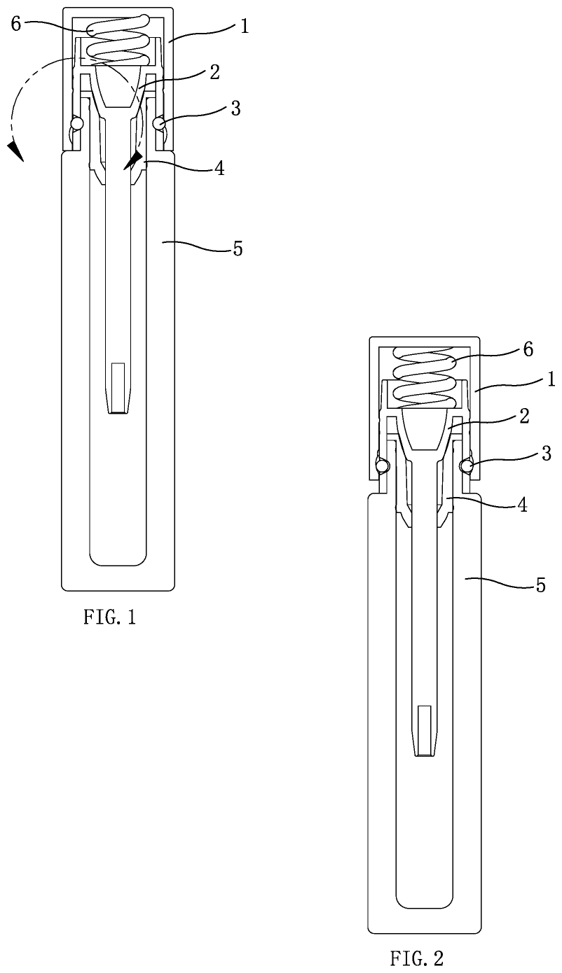

Referring to FIG. 1, this embodiment provides a plug-and-pull ball structure that can be used on tube products such as s mascara and lip gloss. The said structure comprises: an outer cap 1, an inner cap 2, a ball 3 and a bottle body 5; the said outer cap 1 is installed on the outside of the inner cap 2, the combination structure of the said inner cap 2 and the said outer cap 1 is fit to the said bottle body through a plug-and-pull mechanism 5, the said ball 3 is installed on the said inner cap 2. To plug in the said combination structure, the said outer cap 1 will drive the said ball 3 toward the said bottle body 5, so the said ball 3 interferes with the said bottle body 5; to pull out the said combination structure, the said bottle body 5 will drive the said ball 3 toward the said outer cap 1, so the said ball 3 interferes with the said outer cap 1. A spring 6 is disposed between the said inner cap 2 and the closed end of the said outer cap 1, a sealing element 11 is disposed on the side where the said inner cap 2 is away from the closed end of the said outer cap 1, an inner plug 4 is disposed on the inside of the neck part of the said bottle body 5. When the said combination structure is assembled to the said bottle body 5, the said sealing element 11 is interference fit with the inner plug 4 to form the seal.

Referring to FIG. 4, the said movable groove 7, the said first immovable groove 8 and the said second immovable groove 9 are configured as arc surfaces. The distance between the bottom part of the said movable groove 7 and the inside face of the said outer cap 1 is greater than that between the bottom part of the said first immovable groove 8 and the inside face of the said outer cap 1. The said sliding groove 10 is configured as a circular cone form, the diameter of the end face of the sliding groove 10 oriented toward the inside of the side wall of the said inner cap 2 is less than that oriented toward the outside of the side wall of the said inner cap 2 and the diameter of the said ball 3 is larger than the diameter of the end face of the said sliding groove 10 oriented toward the inside of the side wall of the said inner cap 2.

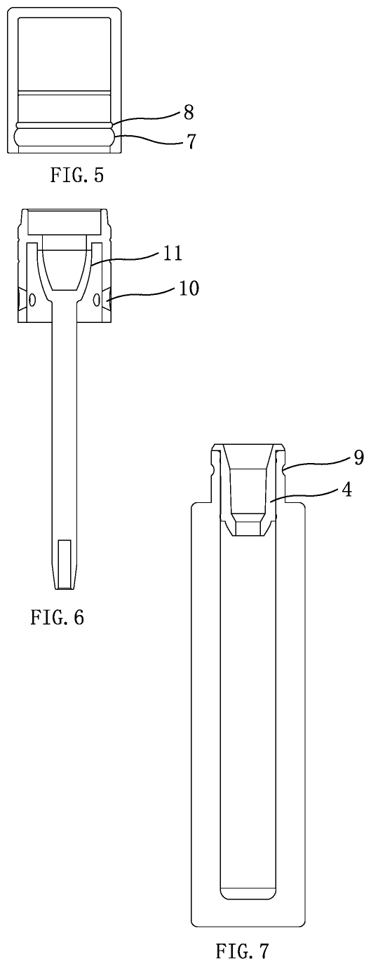

Referring to FIGS. 5-7, the inner wall of the said outer cap 1 is disposed a movable groove 7 and a first immovable groove 8, the said outer cap 1 has one end opened and the other end closed, the said first immovable groove 8 is disposed on the side away from the opening of the said movable groove 7, the said inner cap 2 is installed in the said outer cap 1 from the opening of the said outer cap 1, a sliding groove is disposed on the side wall of the inner cap 2, and the said ball 3 is installed in the said sliding groove 10, a second immovable groove 9 is disposed on the outside of the neck part of the said bottle body 5.

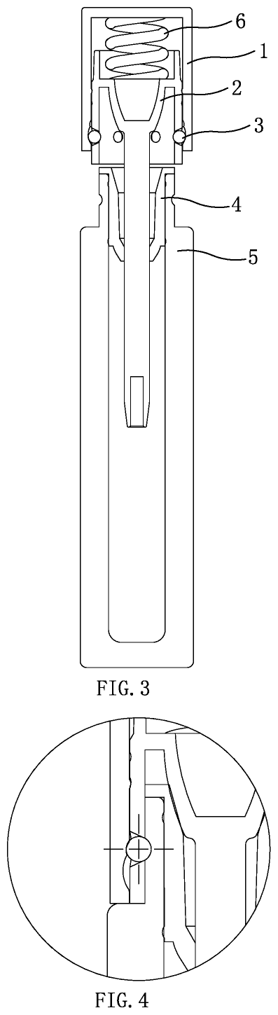

Referring to FIGS. 1-3, when the said combination structure is being plugged in the said bottle body 5, the said movable groove 7 presses the ball 3 on the outside of the neck part of the bottle body 5 until the ball 3 moves in the said second immovable groove 9, and the closed end of the said outer cap 1 drives the inner cap 2 to move; when the said combination structure is installed on the said bottle body 5, one end of the said ball 3 is snapped into the said second immovable groove 9 and interferes with the movement of the bottle body 5, and the other end of the said ball 3 moves from the said immovable groove 7 into the said first immovable groove 8; when the said combination structure is being pulled out of the said bottle body 5, the said outer cap 1 moves relative to the said inner cap 2, one end of the said ball 3 rolls from the said first immovable groove 8 to the said movable groove 7 and disengages from the second immovable groove 9, the said ball 3 will no longer interfere with the bottle body 5, and the said outer cap 1 causes the said inner cap 2 to move as the said ball 3 interferes with the said movable groove 7; when the combination structure is being disengaged from the said bottle body 5, the said outer cap 1 causes the said inner cap 2 to move as the said ball 3 interferes with the said movable groove 7.

### Embodiment 2

### Embodiment 2 is a Preferred Example of Embodiment 1

As shown in FIGS. 1-7, the closing mechanism of the combination structure and the bottle body 5: the down pressure acting upon the outer cap 1 causes the ball 3 in the sliding groove 10 of the inner cap 2 to snap into the first immovable groove 8 and the second immovable groove 9 through the movable groove 7. Once snapped into the first immovable groove 8 and the second immovable groove 9, the ball 3 functions as a pin for immobilizing the outer cap 1, the inner cap 2 and the bottle body 5 so that the connection is securely immobilized. In the meanwhile, the sealing element 11 on the inner cap 2 forms a press-down interference fit with the inner plug 4 so that the sealing effect is attained.

The disengaging mechanism of the combination structure from the bottle body 5: the pull-out force acting upon the outer cap 1 causes the ball 3 in the inner cap 2 to move from the first immovable groove 8 to the movable groove 7, so that the ball 3 is disengaged from the second immovable groove 9 at the neck part of the bottle body 5, setting aside the space between the ball 3 and the second immovable groove 9, so that the combination structure disengages from the bottle body 5.

### Embodiment 3

Embodiment 3 is a preferred example of Embodiment 1 and Embodiment 2.

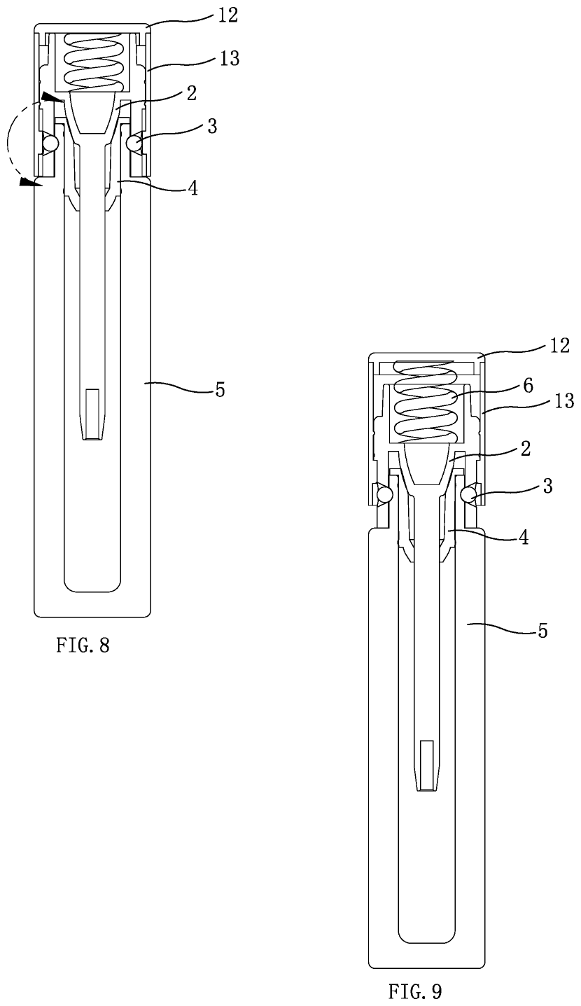

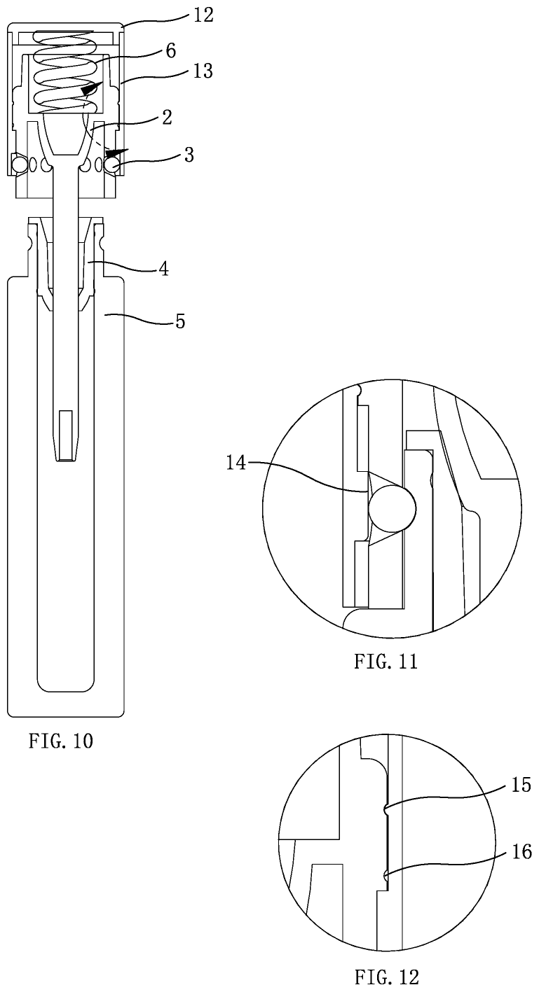

As shown in FIGS. 8-11, the said outer cap 1 comprises an upper outer cap 12 and a lower outer cap 13, the said lower outer cap 13 is installed on the outside of the said inner cap, and the said upper outer cap 12 is installed on the top of the said lower outer cap 13 and the said inner cap 2. The protrusion 14 from the side wall inside the lower outer cap 13 is set against the said ball 3, and the outer diameter of the side wall of the said inner cap 2 in the upper and lower parts of the protrusion 14 is less than the outer diameter of the side wall of the said inner cap 2. The first slot 15 and the second slot 16 on the side wall outside the inner cap 2 above the said protrusion 14 disposed on the side wall inside the said lower outer cap 13. A rib is disposed on the side wall outside the lower outer cap. For the closing mechanism of the combination structure from the bottle body 5, and the disengaging mechanism of the combination structure from the bottle body 5, refer to the operation steps as detailed in Embodiments 1 and 2.

The closing mechanism of the combination structure and the bottle body 5: the down pressure acting upon the combination structure causes the ball 3 in the sliding groove 10 of the inner cap 2 to snap into the protrusion 14 from the outside of the side wall of the inner cap 2 underneath the protrusion 14. Once snapped into the protrusion 14, the ball 3 functions as a pin for immobilizing the combination structure, the inner cap 2 and the bottle body 5 so that the connection is securely immobilized. In the meanwhile, the sealing element 11 on the inner cap 2 forms a press-down interference fit with the inner plug 4 so that the sealing effect is attained.

The disengaging mechanism of the combination structure from the bottle body 5: the pull-out force acting upon the combination structure causes the ball 3 in the inner cap 2 to move from the protrusion 14 into the outside of the side wall of the inner cap 2 underneath the protrusion 14, so that the ball 3 is disengaged from the second immovable groove 9 at the neck part of the bottle body 5, setting aside the space between the ball 3 and the second immovable groove 9, so that the combination structure disengages from the bottle body 5.

As described herein, it should be understood that the terms indicating the orientation or positional relationship, including “upper”, “lower”, “front”, “rear”, “left”, “right”, “vertical”, “horizontal”, and “top”, is based upon that shown in the drawings, and is only for the convenience of describing the application and simplifying the description, rather than indicating or implying that the referred device or elements must have a certain orientation, be constructed and operated in a certain orientation, so it should not be construed as limiting the present application.

The specific embodiments of the present invention are described above. It should be understood that the present invention is not limited to the above specific embodiments, and those skilled in the art can make some changes or modifications within the scope of the claims, which does not affect the substance of the present invention. If there is no conflict, the embodiments of the present application and the features in the embodiments can be any combination.

1-12. (canceled)

13. A plug-and-pull ball structure, wherein the structure includes: an outer cap, an inner cap, a ball and a bottle body; the outer cap is installed on the outside of the inner cap, the combination structure of the inner cap and the outer cap is fit to the bottle body through a plug-and-pull mechanism; the ball is installed on the inner cap, wherein to plug in the combination structure, the outer cap will drive the ball toward the bottle body, so the ball interferes with the bottle body; to pull out the combination structure, the bottle body will drive the ball toward the outer cap, so the ball interferes with the outer cap.

14. The plug-and-pull ball structure according to claim 13, wherein the inner wall of the outer cap is disposed a movable groove and a first immovable groove, the outer cap has one end opened and the other end closed, the first immovable groove is disposed on the side away from the opening of the movable groove, the inner cap is installed in the outer cap from the opening of the outer cap;
a sliding groove is disposed on the side wall of the inner cap, and the ball is installed in the sliding groove;
a second immovable groove is disposed on the outside of the neck part of the bottle body.

15. The plug-and-pull ball structure according to claim 14, wherein the distance between the bottom part of the movable groove and the inside face of the outer cap is greater than that between the bottom part of the first immovable groove and the inside face of the outer cap.

16. The plug-and-pull ball structure according to claim 14, wherein the sliding groove is configured as a circular cone form, the diameter of the end face of the sliding groove oriented toward the inside of the side wall of the inner cap is less than that oriented toward the outside of the side wall of the inner cap, and the diameter of the ball is larger than the diameter of the end face of the sliding groove oriented toward the inside of the side wall of the inner cap.

17. The plug-and-pull ball structure according to claim 14, wherein the movable groove, the first immovable groove and the second immovable groove are configured as arc surfaces.

18. The plug-and-pull ball structure according to claim 14, wherein a spring is disposed between the inner cap and the closed end of the outer cap.

19. The plug-and-pull ball structure according to claim 14, wherein a sealing element is disposed on the side where the inner cap is away from the closed end of the outer cap, an inner plug is disposed on the inside of the neck part of the bottle body, wherein when the combination structure is assembled to the bottle body, the sealing element is interference fit with the inner plug to form the seal.

20. The plug-and-pull ball structure according to claim 14, wherein the outer cap includes an upper outer cap and a lower outer cap, the lower outer cap is installed on the outside of the inner cap, and the upper outer cap is installed on the top of the lower outer cap and the inner cap.

21. The plug-and-pull ball structure according to claim 20, wherein a protrusion from the side wall inside the lower outer cap is set against the ball, and the outer diameter of the side wall of the inner cap in the upper and lower parts of the protrusion is less than the outer diameter of the side wall of the inner cap.

22. The plug-and-pull ball structure according to claim 20, wherein a first slot and a second slot on the side wall outside the inner cap above the protrusion disposed on the side wall inside the lower outer cap.

23. A mascara tube, wherein the plug-and-pull ball structure according to claim 13 is adopted.

24. A lip gloss tube, wherein the plug-and-pull ball structure according to claim 13 is adopted.
